(19) United States
(12) Patent Application Publication
(10) Pub. No.: US 2014/0360143 A1
(43) Pub. Date: Dec. 11, 2014

(54) CANISTER WOODWORKING FILTER CLEANER

(71) Applicant: Lou Bush, Jacksonville, FL (US)

(72) Inventor: Lou Bush, Jacksonville, FL (US)

(21) Appl. No.: 13/911,154

(22) Filed: Jun. 6, 2013

(51) Int. Cl. B01D 46/00; B01D 46/42

(52) U.S. Cl. CPC B01D 46/0075; B01D 46/4245
USPC 55/304

(57) ABSTRACT

A cleaner for a canister woodworking filter of a dust collector includes a vibrating unit magnetically attached to the top of a canister woodworking filter. The vibrating unit may have a sufficiently compact profile (i.e., low height) to avoid interference with the existing handle. The vibrating unit may be controlled by a controller. The controller may include a remote control unit to remotely wirelessly activate the vibrating unit. The controller may be configured to automatically activate the vibrating unit for a determined period of time after the dust collector ceases running.

### FIELD OF THE INVENTION

This invention relates generally to dust collectors, and, more particularly, to a device for cleaning a canister filter of a woodworking dust collector.

### BACKGROUND

A wood shop dust collector uses suction to capture chips, wood dust and debris that would otherwise pile up around a work area and contaminate the air with irritating and harmful airborne contaminants that can harm lungs. By capturing dust at the source with a wood dust collector, work areas are kept clean and the air remains pure.

A popular type of dust collector uses a canister (aka cartridge) filter. Such filters offer better filtration and better airflow than older bag filters. Typically, the filter material in cartridge filters is comprised of spun-bond polyester, capable of filtering dust particles down to microns, as compared to woven fabric bag filters that struggle to retain dust at microns. A cartridge filter also offers much more filter area than a typical bag filter because the filter material is folded or pleated like an accordion in the canister. The pleated filter design fits substantial material into a small package. The increased filter area makes it easier for air to flow through the filter.

Routine cleaning of a cartridge filter does not require removal of the cartridge from the collector. Rather, conventional cartridge filters contain a set of offset paddles in the filter. An external rotating handle is coupled to the paddles. Rotating the handle causes the paddles to rotate. As the paddles rotate, they agitate pleats of the cartridge filter by scraping against the pleats. The agitation loosens caked on dust, which then falls from the pleats into a plastic collection bag for easy disposal.

Unfortunately, the paddles must be manually operated. Manual operation is not always convenient in a woodworking shop. The dust collector may be a distance from a workspace. Limited space for manipulation of the handle may be available around the dust collector.

Additionally, while the paddles help release much dust from the pleated filter, some dust remains. The action of the paddles scraping across pleats actually presses some dust into the pleats. Concomitantly, the paddles do not dislodge dust in many portions of the filter, such as the deepest recesses of the folds of the pleat. Accumulated dust reduces air flow and compromises the effectiveness of the filter.

Simply discarding the filter is not a practical option. The filter is expensive. A replacement filter may cost several hundred dollars.

What is needed is a device that works with conventional canister dust collectors to help dislodge accumulated dust retained in the filter. The device should not interfere with normal use of the dust collector. The device should be easy to install, use and remove. The device should also allow automated and/or remote activation.

The invention is directed to overcoming one or more of the problems and solving one or more of the needs as set forth above.

### SUMMARY OF THE INVENTION

To solve one or more of the problems set forth above, an exemplary cleaner for a canister woodworking filter is provided. The canister woodworking filter includes a generally cylindrical pleated dust filter having a top, a longitudinal axis extending through a centerline of the generally cylindrical pleated dust filter having a pleated filter material, an interior space and a cover at the top of the dust filter. The cleaner includes a housing having a top surface, a bottom surface and a height measured from the bottom surface to the top surface; an eccentric mass motor contained in the housing, the eccentric mass motor having a shaft substantially in parallel alignment with the longitudinal axis of the dust filter; a power supply for supplying electric power to the eccentric mass motor; and an attachment for securing the bottom surface of the housing to the cover at the top of the dust filter. The eccentric mass motor induces vibrations in the dust filter, in a controlled manner, to release dust accumulated in the dust filter.

An exemplary control module is operably coupled to the power supply. For example, an A/C to D/C transformer with a plug attached to a cord leading to the eccentric mass motor is plugged into a receptacle of the control module. The control module includes an A/C plug for utility power from a wall outlet. The control module also includes a relay having a first lead, a second lead and a control lead. The relay is switchable between a first state in which the first lead is electrically coupled to the second lead and a second state in which the first lead is not electrically coupled to the second lead in response to signals received via the control lead. A control circuit is electrically coupled to the control lead of the relay. A user interface (e.g., switches, buttons, dials, and/or a remote control) is operably coupled to the control circuit. The user interface provides signals corresponding to user input to the control circuit. The control circuit controls the relay in response to the user input.

In one embodiment, the user interface is a remote control unit. In such embodiment, the control module includes a radio receiver operably coupled to the control circuit, and a receiving antenna operably coupled to the radio receiver. A remote control unit includes a transmitter, a transmitter control circuit operably coupled to the transmitter, a transmitting antenna operably coupled to the transmitter, and a user selectable switch operably coupled to the transmitter control circuit. The remote control unit transmits radio frequency signals in response to user activation of the user selectable switch. The radio receiver receives the transmitted radio frequency signals via the receiving antenna. The control circuit controls the relay in response to the user input.

In another embodiment, a potentiometer (e.g., rheostat) is electrically coupled to the second lead of the relay between the second lead and the receptacle. The potentiometer controls resistance.

The canister woodworking filter may include a handle attached to a shaft. The shaft extends through the cover of the dust filter at about the centerline of the dust filter. A portion of the shaft extends above the cover. Another portion of the shaft extends into the interior space of the dust filter. The handle is attached to the portion of the shaft extending above the cover. A paddle attached to the other portion of the shaft extends into the interior space of the dust filter. The paddle extends radially from the shaft a distance sufficient to reach the pleated filter material. The handle and the cover are separated by a first distance and the height of the housing is less than the first distance.

A preferred attachment for securing the bottom surface of the housing to the cover at the top of the dust filter is a magnet, such as a samarium-cobalt magnet or a neodymium-iron-boron magnet. The cover may include a material that is magnetically attracted to the magnet, or may have magnets attached to the cover. In this manner the cleaner is easily removable.

The canister woodworking filter includes a blower driven by a blower motor. The blower motor receives electrical power from a power source via an electrical cord. In one embodiment, the control module may include a current sensor (e.g., a hall effect sensor or other type of current sensor) sensing current in (e.g., supplied to) the electrical cord. The current sensor is operably coupled to the control circuit. The control circuit determines if the blower motor is running based upon the sensed current. An analog-to-digital converter may be disposed between the current sensor and the control circuit to convert analog signals from the sensor to digital signals, if required by the control circuit. In such an embodiment, the control circuit may switch the relay to the first state after the blower motor ceases running and then switch the relay to the second state after a determined period of time after the blower ceases running.

The eccentric mass motor may be a 12 volt DC eccentric mass motor with a normalized vibration amplitude of at least 25 G and a rated speed of at least 1,000 rpm.

Optionally, a mode selector switch may be coupled to the control circuit. The mode selector switch provides a plurality of positions with one position for each of a plurality of modes of operation including a mode of operation in which the eccentric mass motor runs for a determined period of time after the blower motor ceases running.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a front view of an exemplary canister woodworking filter with an attached exemplary vibrating module according to principles of the invention; and

FIG. 2 is a top perspective view of an exemplary canister woodworking filter with an attached exemplary vibrating module according to principles of the invention; and

FIG. 3 is a plan view of an exemplary vibrating module for a canister woodworking filter according to principles of the invention; and

FIG. 4 is a side view of an exemplary vibrating module for a canister woodworking filter according to principles of the invention; and

FIG. 5 is a top perspective view of an exemplary vibrating module for a canister woodworking filter according to principles of the invention; and

FIG. 6 is a bottom perspective view of an exemplary vibrating module for a canister woodworking filter according to principles of the invention; and

FIG. 7 is a top perspective view of an exemplary eccentric mass motor for vibrating module for a canister woodworking filter according to principles of the invention; and

FIG. 8 is a front view of an exemplary eccentric mass motor for vibrating module for a canister woodworking filter according to principles of the invention; and

FIG. 9 is a plan view of an exemplary eccentric mass motor for vibrating module for a canister woodworking filter according to principles of the invention; and

FIG. 10 is a first top perspective exploded view of an exemplary vibrating module for a canister woodworking filter according to principles of the invention; and

FIG. 11 is a second top perspective exploded view of an exemplary vibrating module for a canister woodworking filter according to principles of the invention; and

FIG. 12 is a plan view of an exemplary control module for a vibrating module for a canister woodworking filter according to principles of the invention; and

FIG. 13 is a top perspective view of an exemplary control module for a vibrating module for a canister woodworking filter according to principles of the invention; and

FIG. 14 is a top perspective view of another exemplary control module for a vibrating module for a canister woodworking filter according to principles of the invention; and

FIG. 15 is a side view of another exemplary control module for a vibrating module for a canister woodworking filter according to principles of the invention; and

FIG. 16 is a top perspective view of a remote control unit for a control module for a vibrating module for a canister woodworking filter according to principles of the invention; and

FIG. 17 is a high level block diagram of a control module for a vibrating module for a canister woodworking filter according to principles of the invention; and

FIG. 18 is a front view of a filter with imaginary x, y and z axes to illustrate relative positions and directions; and

FIG. 19 is a top perspective view of a filter with imaginary x, y and z axes to illustrate relative positions and directions; and

FIG. 20 is a high level block diagram of a remote control module for activating a control module for a vibrating module for a canister woodworking filter according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

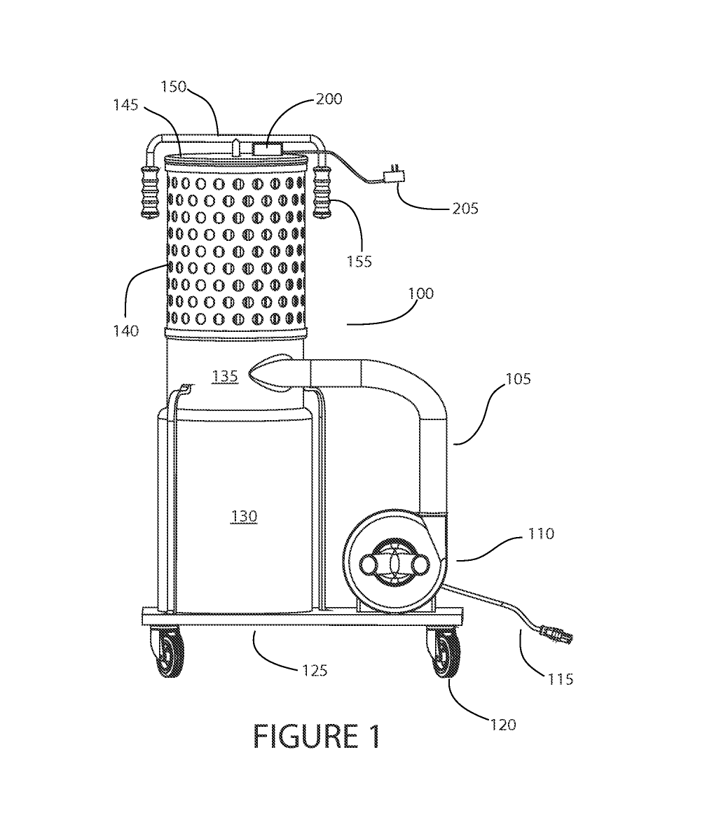

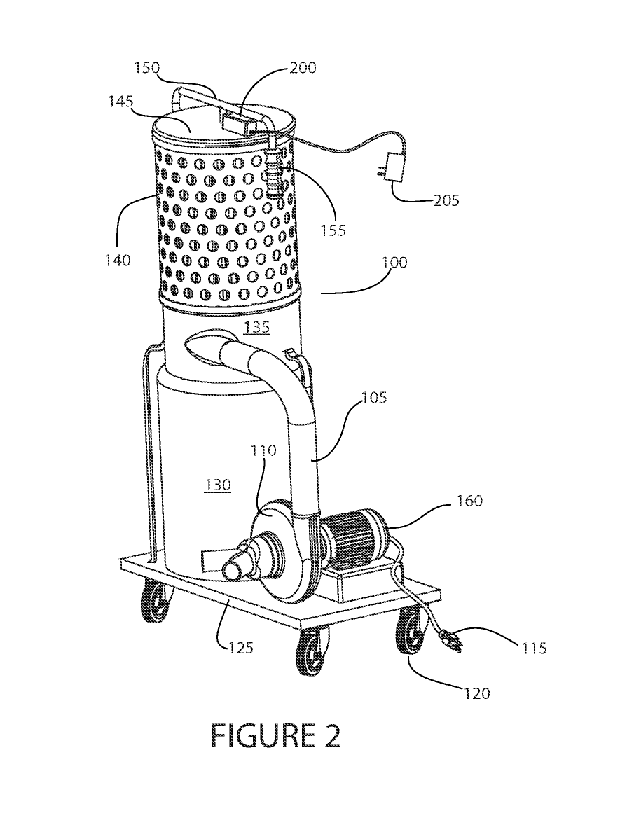

With reference to FIGS. 1 and 2, an exemplary canister woodworking filter unit 100, also known as a dust collector, is conceptually illustrated. The dust collector 100 collects dust and other impurities from woodworking processes, such as sawing, sanding, drilling, routing, planing and turning. Designed to handle high-volume dust loads, the dust collector 100 includes a blower 110, dust filter 140, a filter-cleaning system 150, and a dust receptacle 130. Tubes (not shown) extend from woodworking equipment or work spaces to one or both inlets of the blower 110. The blower 110 draws in air and dust and propels the air and dust through an outlet conduit 105 into a housing unit 135. A canister filter assembly 140 allows air to escape, while dust particles are either captured in a pleated filter or fall into a collection bag 130. A metallic disc 145 covers the top of the canister filter assembly 140. A rotating handle 150 with hand grips 155 is coupled to a paddle in the interior of the filter assembly 140. Rotating the handle 150 causes the internal paddle to rotate. The paddle is configured to scrape against the pleats of the filter 140 to dislodge caked on dust. The dislodged dust falls into the collection bag 130. A standard A/C power cord 115 provides electrical power from an outlet to drive the blower 110. Any of various on/off switches may be provided to activate and deactivate the dust collector 100. In the exemplary embodiment, the unit 100 is mounted on a platform 125 supported by casters 120 to facilitate movement.

Also shown in FIGS. 1 and 2 is an exemplary vibrating module 200 for the dust collector 145 according to principles of the invention. The vibrating module 200 is attached to the metallic disc 145 that covers the top of the canister filter assembly 140. A power cord 205 extends from the vibrating module 200.

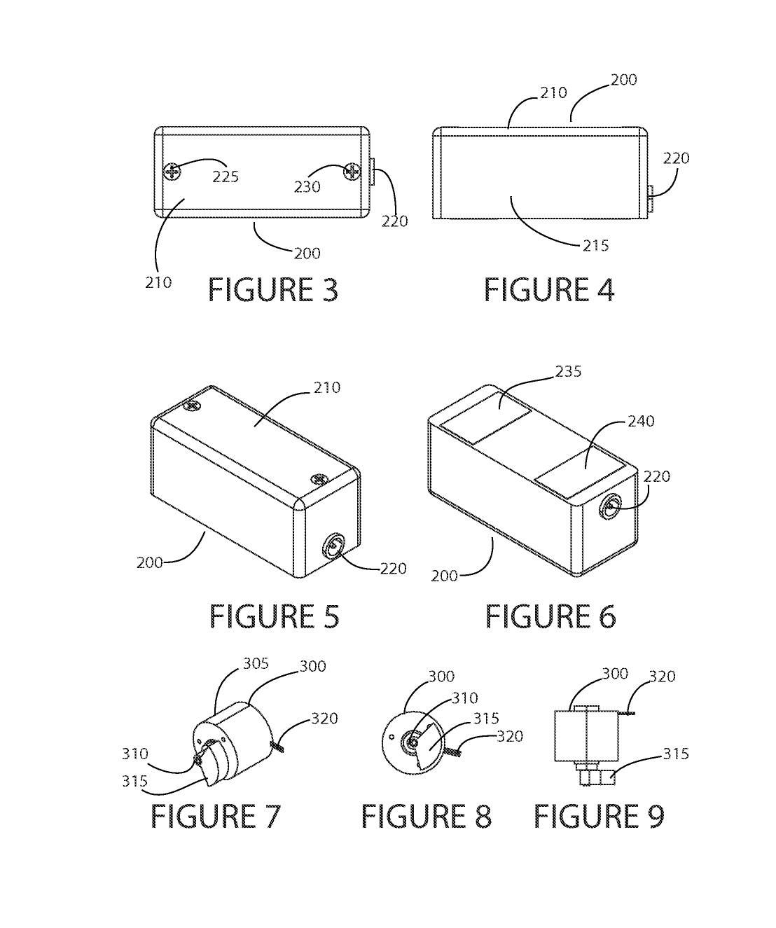

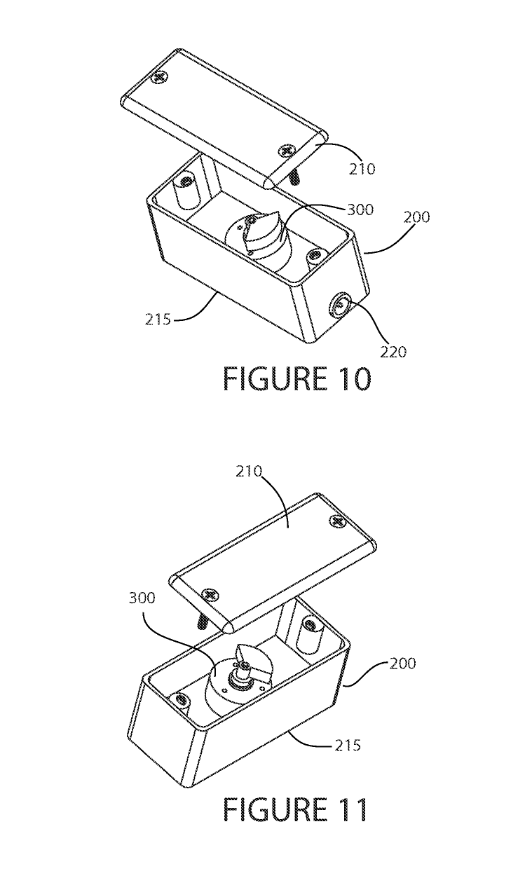

The exemplary vibration module 200 and its components are better shown in FIGS. 3 through 11. The module 200 comprises an enclosure 215 with a removable panel 210 attached by fasteners such as snap fit connections or screws 225, 230. The shape of the module may vary without departing from the scope of the invention. In a particular preferred embodiment, the height, h, of the module 200 is less than the distance between the handle 150 and the top 145 of the filter 140. In such an embodiment, referred to as a “low profile” module, the handle 150 may be rotated without removing and without interference from the module 200. In an alternative embodiment, the height of the module 200 may equal or exceed the distance between the handle 150 and the top 145 of the filter 140. In such embodiments, use of the handle 150 may require removal of the module 200.

A power port 220 is provided for releasably connecting a power supply cord 205. In a low profile embodiment, temporarily unplugging the power supply cord 205 from the port 220 facilitates rotation of the handle without interference from a cord. In an alternative embodiment, the power supply cord 205 may be hard wired to the module 200. In yet another alternative embodiment, the module 200 may contain a battery compartment for battery power, in lieu of or as an additional user-selectable alternative power source.

The exemplary vibrator module 200 is releasably attached to the top 145 of the filter 140. Certain filters have a top 145 comprised of ferromagnetic (or ferrimagnetic) materials. In such embodiments, the vibrator module 200 may be magnetically attached to the top 145. Magnets 235, 240 are shown attached to the bottom of the module 200 in FIG. 6. The shape of the magnets 235, 240 is not particularly important. The magnets 235, 240 are preferably sized to fit at the bottom surface of the module 200 without extending past the periphery of the module. In a particular preferred embodiment, the magnets 235, 240 are comprised of rare-earth elements. By way of example and not limitation, the magnets 235, 240 may be samarium-cobalt or neodymium-iron-boron (NIB) magnets, either of which provides sufficient force to retain the vibrator in place on the top 145 of the filter 140.

In alternative embodiments, the vibrator module may be attached to the top 145 of the filter 140 using means of attachment other than magnets. By way of example and not limitation, clips that grip the periphery of the top 145, or nuts and bolts, or adhesive may be utilized without departing from the scope of the invention. In another embodiment, if the top 145 is plastic, aluminum or another material that is neither ferromagnetic nor ferrimagnetic, magnets may be bonded to the top 145. In such an embodiment, the magnets 235, 240 of the module 200 may attach to the magnets on the top 145 of the filter 140. In yet another embodiment, the vibrator module 200 may be held to the filter by a strap or belt that is securely fastened around the periphery of the filter 140. In all embodiments, the module 200 is attached to the filter 140, preferably at the top of the filter 140.

The vibrator module 200 contains an electromechanical device that generates vibrations. In a preferred embodiment, vibrations are generated by an electric motor with an unbalanced mass on its drive shaft. Such a motor is known as an eccentric mass motor. FIGS. 7 through 9 conceptually illustrate an exemplary eccentric mass motor 300. The motor includes a housing 305, a rotating shaft 310, an eccentric mass 315, and wire leads 320. The motor is bonded, cemented, clamped, bolted or otherwise affixed in the housing 215 of the vibrator module 200. Vibration of the motor 300 causes the housing 215 to vibrate, which causes that filter 140 to vibrate.

A nonlimiting example of a suitable eccentric mass motor is a 345-400 vibration motor by Precision Microdrives of London, England, which is about 44 mm from the outermost surface of the eccentric mass to the opposite back end of the motor housing. The housing 215 must be only slightly larger than the enclosed motor 300. Thus, a compact motor 300, allows a compact housing 215, which may fit beneath the handle 150 of the dust collector 100. The 345-400 motor is a 12 volt DC motor with a typical normalized vibration amplitude of about 115 G, a rated speed of 5,000 rpm, and a typical operating current of about 150 mA. In a preferred implementation, the normalized vibration amplitude is at least 25 G, more preferably at least 50 G, and even more preferably at least 75 G. Concomitantly, in a preferred embodiment, the speed is at least 1,000 rpm, more preferably at least about 2,500 rpm, and even more preferably at least about 4,000 rpm.

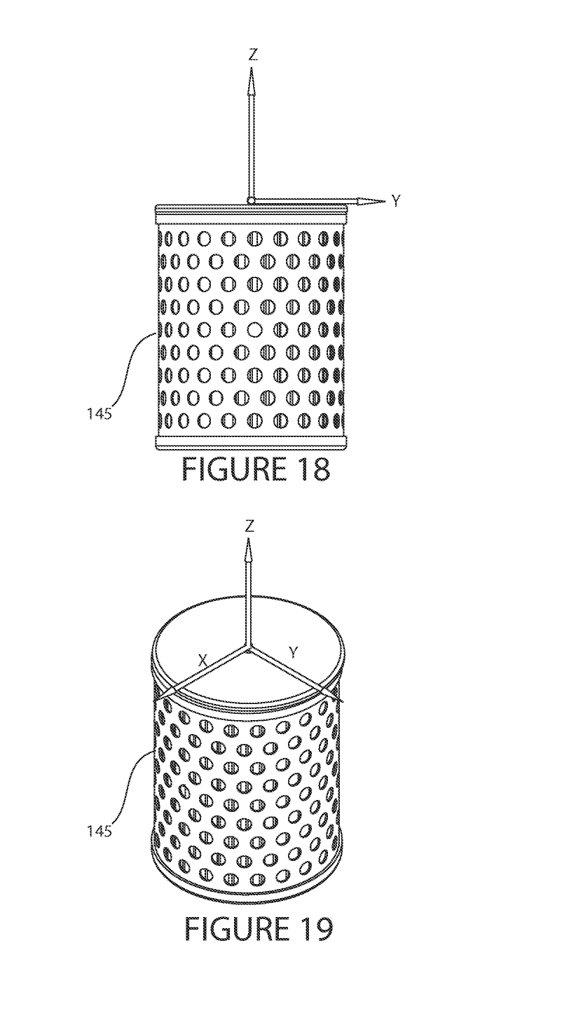

In the exemplary embodiment the shaft of the motor 310 extends upwardly from the top 145 of the filter 140. The shaft is thus substantially parallel to the longitudinal axis of the filter 140, i.e., axis z in FIGS. 18 and 19. In this configuration, the vibrator induces high frequency (e.g, greater than 50 Hz) oscillatory motion in the filter 140 in a plane that is perpendicular to the longitudinal axis (e.g., side to side oscillations), i.e., the x-y plane in FIGS. 18 and 19. As the eccentric mass rotates, it experiences a centripetal force, which in turn exerts a centrifugal force on the housing 215 of the module 200. The induced high frequency oscillatory motion of the filter 140 dislodges dust trapped in the filter 140 that the paddle driven by the handle 150 might not otherwise dislodge.

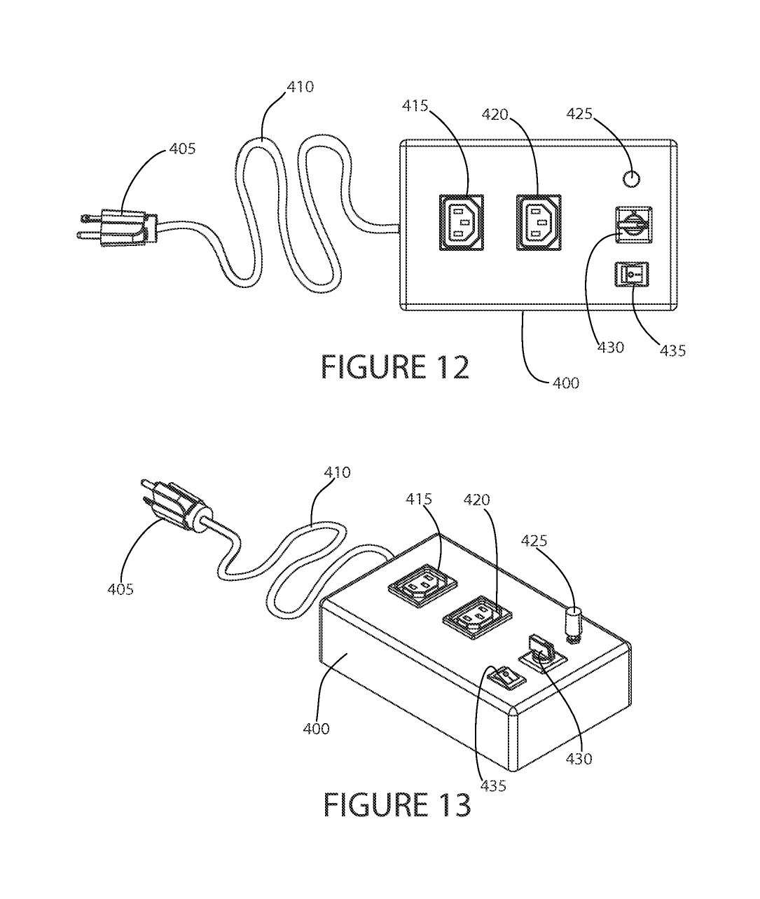

Referring now to FIGS. 12 through 16, various controllers are conceptually illustrated. In FIGS. 12 and 13, the controller 400 includes an AC plug 405 with a power cord 410, at least two receptacles 415, 420, one for the transformer of the vibrating module and the other for AC power to the filter unit, an on/off switch 435, a mode selector switch 430 and a potentiometer (e.g., rheostat) 425. The receptacles 415, 420 may be marked with identifying indicia or color coded to indicate which receptacle should be used for the vibrator module 200 and which receptacle should be used for the dust collector 100.

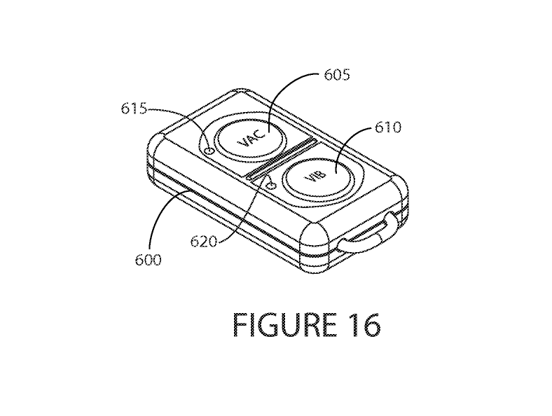

The mode selector switch is an optional component that allows a user to select among various modes of operation. By way of example and not limitation, one mode may be manual which will cause the vibrating module to operate whenever switch 435 is on. Another mode may be a post vacuum mode. In that mode, a current sensor and microcontroller (discussed below) in the controller 400 detect when the blower 110 is running. After the blower 110 ceases running, the vibrator 200 is activated for a determined duration of time. Various modes may be provided for various durations (e.g., 15 s, 30 s, 60 s, etc. . . . ). Yet another mode may be remote activation. In that mode a remote control unit, such as the unit depicted in FIG. 16 may wirelessly communicate an activation (On) signal and a deactivation (Off) signal to the controller to start and stop the vibrator 200. In this embodiment the controller contains a wireless receiver coupled to the microcontroller (also discussed below).

By controlling resistance, a potentiometer 425 regulates voltage supplied to the eccentric mass motor 300, thereby regulating frequency and amplitude of the vibrator 200. In lieu of providing a potentiometer 425 on the controller 400, a potentiometer may be provided on the vibrator module 200, or simply omitted. An advantage of the potentiometer is that the amplitude and frequency of vibration may be controlled. Depending upon the particular configuration of dust collector and the strength of the magnetic attachments, the amplitude and frequency may be dialed up or down to provide adequate oscillatory motion without excessive noise, rattling and dislodging the vibrator module 200.

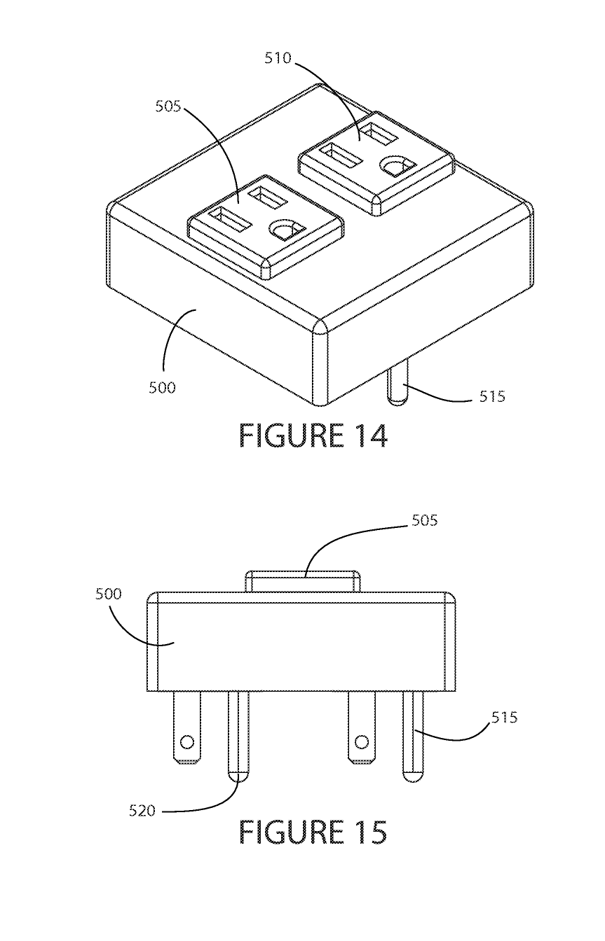

In FIGS. 14 and 15, the controller 500 includes AC plugs 515, 520 for engaging a standard AC outlet, and at least one receptacle but preferably two receptacles 505, 510, one for the transformer of the vibrating module and the other for AC power to the filter unit. Internally, an antenna, wireless receiver, microcontroller and relay are provided, as discussed below. This controller may be activated (i.e., turned on) and deactivated (i.e., turned off) using a remote control unit, such as the remote control unit 600 shown in FIG. 16.

In FIG. 16, a remote control unit 600 is shown. The remote control unit 600 may work with any compatible controller, such as, but not limited to, the controller in FIGS. 12 and 13 and the controller in FIGS. 14 and 15. The remote control unit includes on/off switches 605, 610 for the dust collector 100 and for the vibrator unit 200. A status light 615, 620 may be provided for each switch 605, 610 to visibly indicate whether the switch is on or off.

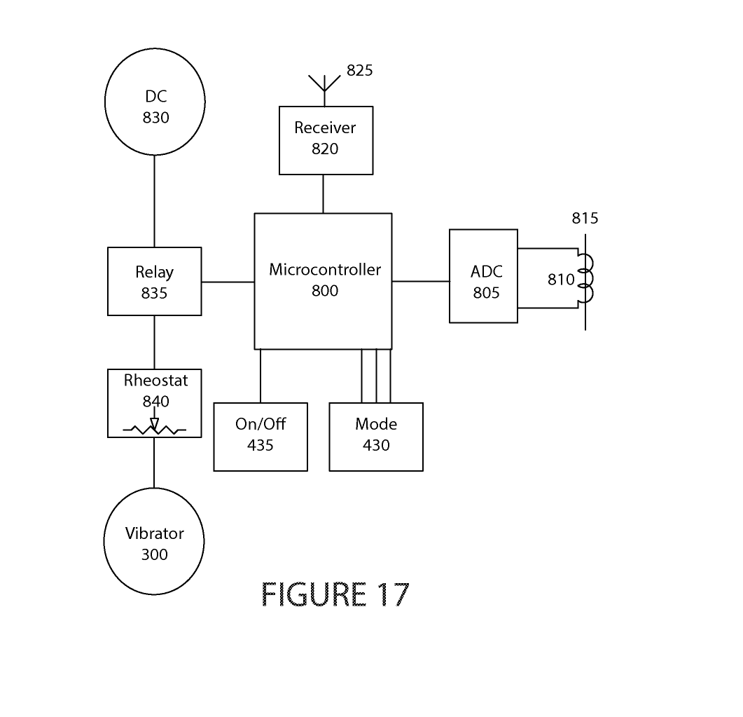

Referring now to FIG. 17, a high level block diagram of control module electronics for a vibrating module for a canister woodworking filter according to principles of the invention is shown. This particular embodiment includes several optional features. The exemplary controller electronics include a microcontroller 800 which receives, stores and processes signals and data and generates output. The microcontroller 800 comprises a processor core, memory, and programmable input/output pins. The pins are software configurable to either an input or an output state. When configured to an input state, the pins may be used to read a sensor or receive external signals, such as signals from a receiver. If the microcontroller contains an analog-to-digital converter (ADC), one more separate analog-to-digital converters 805 may not be necessary. The analog to digital converter 805 converts incoming analog signals from a current sensor 810 into a digital form that the microcontroller 800 can recognize. Additional inputs to the microcontroller 800 may include on/off switch 435 and mode selector switch 430 inputs.

The current sensor 810, which is an optional feature, monitors the current in a power line 815 to the motor 160. The current sensor 810 is a device that detects electrical current (AC or DC) in a wire, and generates a signal proportional to it. The generated signal could be analog voltage or current or even digital output. In the case of an analog output, the signal may be converted to digital and then provided to the microcontroller 800. Nonlimiting examples of current sensors include a Hall effect IC sensor, a transformer or current clamp meter (suitable for AC current), a resistor, whose voltage is directly proportional to the current through it, a fiber optic current sensor, using an interferometer to measure the phase change in the light produced by a magnetic field or a Rogowski coil. A Hall effect sensor is preferred for its availability and reliability. By monitoring the current in the power supply line 815, the controller can determine when the motor 160 is running and when it has stopped running, without interfering with the motor's operation.

In the embodiments of FIGS. 12 through 15, the controller is remotely activated. Thus, the controller electronics may include a radio receiver to receive signals from the transmitter 600 and convert them to a form for processing by the microcontroller 800. An antenna 825 intercepts radio waves and converts them to alternating currents which are applied to the radio receiver 820. The receiver 820 uses electronic filters to separate desired radio frequency signals from all the other signals picked up by the antenna. The receiver 820 also amplifies the filtered signals and extracts desired information from the waves by demodulation. In this manner, the microcontroller 800 may determine whether to activate or deactivate the vibrator module 200.

A relay 835 is operably coupled to the microcontroller 800. The relay 835 operates as an electrically actuated switch, either breaking or making a complete power supply circuit to the vibrator module 200. Configured to the output state, the microcontroller 800 pins can drive external devices such as the relay 835. If the microcontroller does not contain a digital-to-analog converter (DAC) that allows the microcontroller to output analog signals or voltage levels, then a DAC may be operably coupled between the microcontroller and the electrically actuated relay 835 if required by the relay 835. Power supply 830 to the vibrator module 200 passes through the relay 835. Any relay suitable for activating a DC motor in response to output from the microcontroller may be used. Nonlimiting examples include a latching relay, a reed relay, a ratchet relay, a solid state relay and a solid state contactor relay.

In operation, the microcontroller 800 may automatically detect when the motor 160 has ceased running. Then, the microcontroller 800 may energize or activate the relay 835, making (i.e., completing) the power supply circuit to the vibrator module 200. After a determined period of time, the microcontroller may de-energize or deactivate the relay 835, thereby breaking the power supply circuit to the vibrator module 200. The determined period of time may be anywhere from a few seconds to a few minutes. However, time periods in the range of 10 to 60 seconds are preferred.

A potentiometer (e.g., rheostat 425) provides an adjustable voltage divider or regulator. By limiting the voltage supplied to the vibrator motor 300, oscillating frequency and amplitude may be controlled. The potentiometer may be set to maximize cleaning efficiency without excessive noise, vibration or dislodging the vibrator module 200, as determined by a user.

The microcontroller 800 may have an internal clock oscillator as a time base for all operations. Alternatively, a crystal and associated circuitry may be utilized for a timing base. The microcontroller 800 may also have internal memory, which may store programming for the controller and a table that determines the duration the vibrator motor 300 must be energized based upon mode selection and/or other parameters.

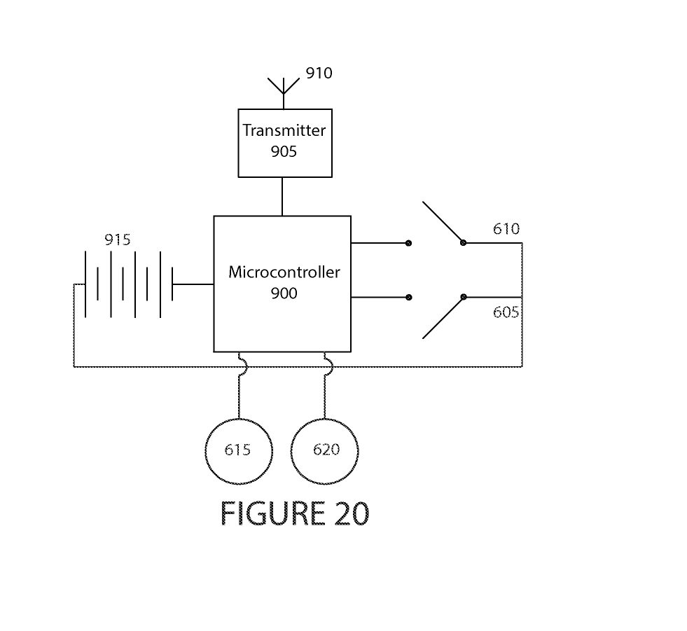

FIG. 20 is a high level block diagram of a remote control module 600 for activating a control module for a vibrating module for a canister woodworking filter according to principles of the invention. The remote control module 600 includes a microcontroller 900 operably coupled to one or more switch inputs 605, 610. In response to switch inputs, the microcontroller 800 outputs codes to an operably coupled transmitter 905. With the aid of an antenna 910, the transmitter 905 produces radio waves. The transmitter 905 itself generates a radio frequency alternating current, which is applied to the antenna 910. When excited by this alternating current, the antenna 910 radiates radio waves. Through modulation, the transmitter combines the information signal to be carried with a radio frequency signal which generates the radio waves, i.e., the carrier. The radio waves are intended to be received and processed by a compatible controller such as, but not limited to, one of the controllers in FIGS. 12 through 15. One or more batteries (e.g., button cells) 915 supply power to the unit.

While the remote control 600 is illustrated with separate switches 605, 610 for activating and deactivating both the vibrating module 200 and the dust collector 100, additional, different and fewer switches may be provided. By way of example, the remote control 600 may be configured with a single switch for the vibrating module 200.

Optionally, the remote control 600 may be equipped with visible output, such as LEDs 615, 620, to indicate whether an activation signal has been sent. For example, a green led 620 may illuminated when the button switch 610 corresponding to the vibrator module has been pressed to activate the vibrator module 200 by wirelessly communicating an activation signal to the controller 400 or 500. When the button switch 610 is pressed again, a deactivation signal is wirelessly communicated to the controller 400 or 500 and the LED 620 is de-energized.

Each LED 615, 620 is a current-driven device. An LED driver, which may be an integral part of the microcontroller 900 supplies a correct amount of current to drive each LED 615, 620. In one embodiment, the LED driver for each LED 615, 620 may be comprised of one or more pins on the microcontroller 900 with a current limiting resistor.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A cleaner for a canister woodworking filter, said canister woodworking filter including a generally cylindrical pleated dust filter having a top, a longitudinal axis extending through a centerline of the generally cylindrical pleated dust filter having a pleated filter material, an interior space and a cover at the top of said dust filter, said cleaner comprising:
a housing having a top surface, a bottom surface and a height measured from the bottom surface to the top surface,
an eccentric mass motor contained in said housing, said eccentric mass motor having a shaft substantially in parallel alignment with the longitudinal axis of the dust filter,
a power supply for supplying electric power to said eccentric mass motor, and
an attachment for securing the bottom surface of the housing to the cover at the top of said dust filter,
said eccentric mass motor controllably inducing vibrations in the dust filter to release dust accumulated in the dust filter.

2. A cleaner for a canister woodworking filter according to claim 1, further comprising a control module operably coupled to the power supply, said control module comprising an A/C plug for utility power from a wall outlet,
a relay having a first lead, a second lead and a control lead, said relay being switchable between a first state in which the first lead is electrically coupled to the second lead and a second state in which the first lead is not electrically coupled to the second lead in response to signals received via the control lead,
a receptacle electrically coupled to the second lead, said receptacle being electrically coupled to the power supply for supplying electric power to said eccentric mass motor,
a control circuit electrically coupled to the control lead of the relay,
a user interface operably coupled to the control circuit, said user interface providing signals corresponding to user input to the control circuit, and said control circuit controlling the relay in response to the user input.

3. A cleaner for a canister woodworking filter according to claim 2, said user interface comprising
a radio receiver operably coupled to said control circuit, and a receiving antenna operably coupled to said radio receiver, and
a remote control unit comprising a transmitter, a transmitter control circuit operably coupled to the transmitter, a transmitting antenna operably coupled to the transmitter, and a user selectable switch operably coupled to the transmitter control circuit, said remote control unit transmitting radio frequency signals in response to user activation of the user selectable switch, and
said radio receiver receiving said transmitted radio frequency signals via said receiving antenna, and said control circuit controlling the relay in response to the user input.

4. A cleaner for a canister woodworking filter according to claim 2, a potentiometer electrically coupled to the second lead between the second lead and the receptacle, said potentiometer controlling resistance.

5. A cleaner for a canister woodworking filter according to claim 1, said canister woodworking filter further comprising a handle attached to a shaft, said shaft extending through the cover of the dust filter at about the centerline of the dust filter, a portion of the shaft extending above the cover, another portion of the shaft extending into the interior space of the dust filter, and said handle being attached to the portion of the shaft extending above the cover, and a paddle attached to the other portion of the shaft extending into the interior space of the dust filter, said paddle extending radially from the shaft a distance sufficient to reach the pleated filter material, and the handle and the cover being separated by a first distance, and the height of the housing being less than the first distance.

6. A cleaner for a canister woodworking filter according to claim 1, said attachment for securing the bottom surface of the housing to the cover at the top of said dust filter comprising a magnet, and said cover comprising a ferromagnetic material.

7. A cleaner for a canister woodworking filter according to claim 1, said attachment for securing the bottom surface of the housing to the cover at the top of said dust filter comprising a magnet, and said cover comprising a ferrimagnetic material.

8. A cleaner for a canister woodworking filter according to claim 1, said attachment for securing the bottom surface of the housing to the cover at the top of said dust filter comprising a magnet from the group consisting of a samarium-cobalt magnet and a neodymium-iron-boron magnet and said cover comprising a material that is magnetically attracted to said magnet.

9. A cleaner for a canister woodworking filter according to claim 1, said attachment for securing the bottom surface of the housing to the cover at the top of said dust filter being a removable attachment allowing the housing to be removed from the cover.

10. A cleaner for a canister woodworking filter according to claim 2, said canister woodworking filter further comprising a blower driven by a blower motor, and said blower motor receiving electrical power from a power source via an electrical cord, and said control module further comprising a current sensor sensing current in the electrical cord, said current sensor being operably coupled to the control circuit, said control circuit determining if the blower motor is running based upon the sensed current.

11. A cleaner for a canister woodworking filter according to claim 10, further comprising an analog-to-digital converter operably disposed between the current sensor and the control circuit.

12. A cleaner for a canister woodworking filter according to claim 10, the current sensor comprising a hall effect sensor.

13. A cleaner for a canister woodworking filter according to claim 10, the control circuit switching the relay to the first state after said blower motor ceases running and then switching the relay to the second state after a determined period of time after said blower ceases running.

14. A cleaner for a canister woodworking filter according to claim 1, the eccentric mass motor comprising a 12 volt DC eccentric mass motor with a normalized vibration amplitude of at least 25 G and a rated speed of at least 1,000 rpm.

15. A cleaner for a canister woodworking filter according to claim 10, further comprising a mode selector switch operably coupled to said control circuit, said mode selector switch providing a plurality of positions with one position for each of a plurality of modes of operation including a mode of operation in which the eccentric mass motor runs for a determined period of time after the blower motor ceases running.

16. A cleaner for a canister woodworking filter, said canister woodworking filter including a generally cylindrical pleated dust filter having a top, a longitudinal axis extending through a centerline of the generally cylindrical pleated dust filter having a pleated filter material, an interior space and a cover at the top of said dust filter, said cleaner comprising:
a housing having a top surface, a bottom surface and a height measured from the bottom surface to the top surface, and
an eccentric mass motor contained in said housing, said eccentric mass motor having a shaft substantially in parallel alignment with the longitudinal axis of the dust filter, and
a power supply for supplying electric power to said eccentric mass motor, and
a magnet for securing the bottom surface of the housing to the cover at the top of said dust filter, and
said eccentric mass motor controllably inducing vibrations in the dust filter to release dust accumulated in the dust filter, and
a control module operably coupled to the power supply, said control module comprising
an A/C plug for utility power from a wall outlet,
a relay having a first lead, a second lead and a control lead, said relay being switchable between a first state in which the first lead is electrically coupled to the second lead and a second state in which the first lead is not electrically coupled to the second lead in response to signals received via the control lead,
a receptacle electrically coupled to the second lead, said receptacle being electrically coupled to the power supply for supplying electric power to said eccentric mass motor,
a control circuit electrically coupled to the control lead of the relay,
a user interface operably coupled to the control circuit, said user interface providing signals corresponding to user input to the control circuit, and said control circuit controlling the relay in response to the user input, and
said canister woodworking filter further comprising a handle attached to a shaft, said shaft extending through the cover of the dust filter at about the centerline of the dust filter, a portion of the shaft extending above the cover, another portion of the shaft extending into the interior space of the dust filter, and said handle being attached to the portion of the shaft extending above the cover, and a paddle attached to the other portion of the shaft extending into the interior space of the dust filter, said paddle extending radially from the shaft a distance sufficient to reach the pleated filter material, and the handle and the cover being separated by a first distance, and the height of the housing being less than the first distance.

17. A cleaner for a canister woodworking filter according to claim 16, said user interface comprising
a radio receiver operably coupled to said control circuit, and a receiving antenna operably coupled to said radio receiver, and
a remote control unit comprising a transmitter, a transmitter control circuit operably coupled to the transmitter, a transmitting antenna operably coupled to the transmitter, and a user selectable switch operably coupled to the transmitter control circuit, said remote control unit transmitting radio frequency signals in response to user activation of the user selectable switch, and
said radio receiver receiving said transmitted radio frequency signals via said receiving antenna, and said control circuit controlling the relay in response to the user input.

18. A cleaner for a canister woodworking filter according to claim 16, a potentiometer electrically coupled to the second lead between the second lead and the receptacle, said potentiometer controlling resistance.

19. A cleaner for a canister woodworking filter according to claim 16, said magnet for securing the bottom surface of the housing to the cover at the top of said dust filter comprising a magnet from the group consisting of a samarium-cobalt magnet and a neodymium-iron-boron magnet and said cover comprising a material that is magnetically attracted to said magnet.

20. A cleaner for a canister woodworking filter according to claim 1, the eccentric mass motor comprising a 12 volt DC eccentric mass motor with a normalized vibration amplitude of at least 25 G and a rated speed of at least 1,000 rpm.
